(19) United States
(12) Patent Application Publication
(10) Pub. No.: US 2017/0189804 A1
(43) Pub. Date: Jul. 6, 2017

(54) Connected Toys System For Bridging Between Physical Interaction Of Toys In Reality To Virtual Events

(71) Applicant: Seebo Interactive Ltd., Tel Aviv (IL)

(72) Inventors: Lior Akavia, Tel Aviv (IL); Liran Akavia, Tel Aviv (IL); Yarden Hod, Tel Aviv (IL)

(21) Appl. No.: 15/321,171

(22) PCT Filed: Jun. 23, 2015
(86) PCT No.: PCT/IL2015/050643

§ 371 Date: Dec. 21, 2016

Related U.S. Application Data
(60) Provisional application No. 62/015,537, filed on Jun. 23, 2014.

(51) Int. Cl. A63F 13/31; B62J 99/00; A63H 3/28; A63H 33/26; A63F 13/69

(52) U.S. Cl. CPC A63F 13/31; A63H 33/26; A63F 13/69; A63H 3/28; B62J 99/00; A63H 2200/00; B62J 2099/002; B62K 3/002

(57) ABSTRACT

The invention is directed to a connected toy configured to interact with least one another connected toy upon actual meeting with said at least one another connected toy in a state that said toys are non-connected to a smart device, wherein said interaction allows the toy to recognize the at least one another toy and/or to exchange data with said at least one another toy, said recognition data and/or data exchanged between them is being saved on the toy and uploaded to a smart device upon reconnection of the toy to said smart device to report the smart device that an interaction between the toys has occurred, and to allow the smart device to make use of the exchanged data. The invention is further directed to a connected toys system configured to allow data transmission from a game occurring in the reality to a virtual game of the same connected toys.

### TECHNOLOGICAL FIELD OF THE INVENTION

The present invention is in the field of connected objects and the internet of things (IoT). More particularly, the invention is directed to a method and system that bridges between the virtual world and the real world, and allows at least two connected objects that communicate in the virtual world to further communicate and transfer data when they meet in reality while they are in an unconnected state (not connected to their smart devices). The system and method provided herein enable connected objects to communicate and interact in an offline state with minimal energy consumption and further to transmit data obtained during the physical meeting of the objects at a later time and location when each object is connected to its smart device and data may further be analyzed and used in the virtual world.

### BACKGROUND

Toys that have the ability to interact with each other directly are known in the art. Such toys have a complicated technology, they are usually very expensive and the energy consumed in such interaction is relatively high and requires frequent change of batteries or recharging of the toy. In addition, the content and interaction abilities of such toys is limited and permanent by its nature (not dynamic) and it is pre-determined by the manufacturer. In addition, the playing experience in such toys is local as they are not connected and are available to the players involved only when they physically meet with each other. Some examples of such products are:

Hasbro's Furby line of dolls—a Furby is capable of identifying another Furby doll and outputting sounds whenever it does so.
A concept described in an article written by Disney's Zurich research center and presented in the Mobisys 15′ conference, titled “Demo: Bringing the Internet of Toys to Life”. This article describes a communication protocol for low-complexity IPv6-connected devices whose purpose is to maintain a network of toys.

On the other end, connected toys that have the ability to connect and interact and further to be operated by a smart device are available in the market. Such toys are described in details in patent publication number WO2014091491 of the same inventor and incorporated herein by reference. In addition, such connected toys are manufactured by companies like Hasbro and Mattel in their Furby Boom and Apptivity product lines, in which dolls are connected to a smart device that enhances their playing experience.

However, these toys are limited in their interactions with other players in a manner that the playing experience, while they are connected to the smart device, remains in the virtual world and has no expression while they are disconnected from the smart device. In addition, if a physical interaction between players occurs face to face, it has no meaning and it does not reflect later on when they are re-connected to smart devices.

Furthermore, two or more physical toys may play together and interact through a dedicated software application of a game installed on the smart devices connected to each one of the toys, transfer information, share knowledge and functions and cooperate to get to a certain achievement in the game. All these functions exist in prior art virtual games, such as: Call of Duty, Second life, and World of Warcraft. However, in the prior art, when the smart device is not near the player (offline state), the player cannot interact with other players, even if they played together in the virtual world.

The present invention is aim to provide a bridge between the virtual world and the reality and to allow interaction between connected things when they “meet” each other in the reality, wherein data from said interaction is recorded and has some meaning upon reconnection of the connected thing to the connected toy, and vice versa, data obtained in the virtual world may have a significant presentation on a physical object (toy or else) in a subsequent actual meeting of the objects in the reality.

Thus, the present invention provides a novel connected toy and system having ability of connected object to interact with each other and exchange data that may later be implemented in the virtual world when the connected object is connected to a smart device. The concept and technology presented herein may be implemented in various kinds of connected objects and the below description to connected toys is not intended to limit the scoop to connected toys only. In the same manner as will be described below, connected fitness accessories may enrich the training experience and improve the user's performance and achievements.

### SUMMARY OF THE INVENTION

One aspect of the invention is to provide a system for transferring data between a virtual world and the reality in connected things, upon actual meeting of two or more things while they are not connected to smart devices. In the following description and in order to simplify the explanation and demonstration of the invention, the connected thing will be described as a connected toy.

Thus, one main aspect of the invention is directed to a connected toy configured to interact with least one another connected toy upon actual meeting with said at least one another connected toy in a state that said toys are non-connected to a smart device, wherein said interaction allows the toy to recognize the at least one another toy and/or to exchange data with said at least one another toy, said recognition data and/or data exchanged between them is being saved on the toy and uploaded to a smart device upon reconnection of the toy to said smart device to report the smart device that an interaction between the toys has occurred, and to allow the smart device to make use of the exchanged data.

The data being exchanged with the at least one another connected toy in an unconnected state and uploaded to a smart device may for example, the unique ID of the toy, time of encounter, virtual game achievements of the other toy, offline game achievements of the other toy, data received from input and/or output elements of the toy, and historic data on past encounters.

The connected toy comprises a memory which allows it to save data received from the at least one another toy, said data saved may be for example, unique ID of toys, time of encounter, virtual game achievements, offline game achievements, data coming from s input and/or output elements of a toy, and historic data on past encounters.

The ability to interact with at least one another connected toy is obtained by a communication module integrated within said connected toys, said memory, and at least one input element, wherein the communication module comprises at least a processing unit, a software stack and antenna and configured to allow the smart toy to communicate with another connected toy and with a smart device.

In some embodiments, the input element is configured to allow the connected toy to change mode from a power saved unused mode to an operating in-use mode. The input element may be a sensor configured to provide inputs from the surroundings to said communication module.

In some embodiments of the invention, the interaction with the connected toy upon actual meeting while the toys are not connected to a smart device is enabled after each toy performs a specific movement or a sequence of movements.

The connected toy may further comprise at least one output element, wherein upon connecting to and/or receiving data from said at least one another toy in the non-connected state said toy responds by operating at least one output element, to produce an audio and/or a visual signal that is related to the interaction between said toys.

In some embodiments, the connected toy is further configured to do at least one of the following actions: (a) process data received from said at least one another toy and to send data back to the at least one another toy in response to the data received, (b) process data received and save it on its memory, (c) process data received and operate an output element on the toy as a response.

Upon connection of the toy to the smart device, said smart device may use the exchanged data in at least one of the following manners: send the data to a remote server and identify the at least one another toy, receive data from said remote server about the at least one another toy, connect and/or play with the at least one other toy in an online game via the server, present a virtual character of the toy and/or with a virtual character of said at least one another toy, send data to the at least one another toy, present data coming from additional toys previously identified by said smart device, send the data to an analytic system, receive data from an analytic system about said toy and/or about said at least one another toy, update the toy to recognize the at least one another toy in their next meeting, send new configuration package to the toy to respond in a specific way each time the toy will meet the at least one another toy.

Following a virtual meeting of pre-identified connected toys, data created in the virtual interaction is being downloaded from the smart device to the connect toy and expressed in a subsequent meeting/s in a non-connected state with said pre-identified toy by at least one output element comprised in the connected toy.

The connected toy of the invention is also configured to receive software updates from time to time from said smart device upon connection to it, and respond in different manners while being in a non-connected state according to the software updates received from said smart device.

The present invention is also directed to a connected toys system configured to allow data transmission from a game occurring in the reality to a virtual game of the same connected toys, said system comprising: at least two connected toys configured to interact with each other upon actual meeting of said toys in a state that they are unconnected to a smart device; at least two smart devices each is configured to be connected to one of said connected toys; and a server configured to connect with said at least two smart devices; wherein data obtained in the actual meeting is configured to be transferred to the smart devices in a state where each of said connected toys is connected to its smart device, and said smart devices are configured to send said data to the server and receive information and/or other data about the connected toy that it is not connected to.

The server preferably contains a database of all connected toys registered into the system, and their unique IDs, usernames and/or personal details, allowing said connected toys to further recognize each other in the virtual world after an actual meeting in an unconnected to a smart device state has accrued. Data exchanged via the server allows each of the toys to connect to each other in a virtual game, and play together on the said smart devices.

Data obtained in the virtual game, whether if the toys play together or if each toy plays alone, is configured to be sent to the connected toys and saved on the connected toys memory, to influence actual meetings between said connected toys in subsequent games in the reality in a state where each of the toys is unconnected to its smart device.

The connection to the server allows performance of analytics by an analytic sub-system on the data gathered from said connected toys games in said actual meetings, and to analyze their meetings history, best scores, points gathered and ranking compared to other players registered in the system. The analytic sub-system is configured to send back analysis results to the virtual game on said smart devices, so as to allow players to track their achievements and ranking compared to other players in their actual meetings in the unconnected state.

In some embodiments, the connected toys system further comprises a remote PC allowing the virtual game between said connected toys to be updated from time to time via said server.

In some additional embodiments, the connected toys system comprises an Over The Air update system, allowing said server to send update packages to the said smart devices upon pre-defined criterions set by a remote PC, to allow said smart devices to send the over the air update to the connected toys and change their software stack to so as to allow a new interaction between the connected toys in their actual meeting in the non-connected state.

In some embodiments of the invention, at least two connected toys are connected to one smart device, for example when the toys are owned by one user and connected to his smart device, or when two family members each having a connected toy are sharing the same smart device.

The connected toys of the invention preferably have two main states: (a) connected state in which the connected toy is connected to a smart device; and (b) unconnected state, in which the connected toy is not connected to a smart device. In both cases the toy may interact with another toy, however, when the toy interact with at least another toy while it is connected to the smart device, recordation of events and optionally additional data may be recorded in the smart device, and shared via the web with the other toy, and optionally it may further be transmitted to a cloud for further analysis, as it happens, and may have implications on the competition between the players and their achievements and also on other non-connected players that share the same database.

In accordance with the present invention, such recordation of occurrences is also enabled when the connected toys are in an unconnected state, providing the possibility to upload this “invisible” data to the prior achievements of the players in the virtual world upon there subsequent connection to a smart device. The interaction and occurrences in the reality may be stored as data in the connected toy that is further transmitted to the smart device upon subsequent connection.

Furthermore, the interaction between the two or more connected toys upon physical meeting in an unconnected state may also be expressed by the toys and result in a vocal and/or visual output as will be described in details with reference to the figures.

The connected toys provided herein, can be operated is a power save mode in order to save energy and still maintain essential functions such as low energy communication abilities, for example by BLE, when they are not in use either in an offline or in an online state. Such economic management of power consumption allows a longer playing duration between charging sessions, and a “greener” toys/items that do not transmit constantly.

In other words, the connected toys/things of the invention have additional benefit relative to currently available connected toys as they have ability to communicate with each other in an unconnected state, i.e. when they are not connected to a smart device, in order to use the data that was gathered in the offline state while the toy/thing is re-connected to the smart device. As such, occurrences and achievements between players in the reality may have a virtual expression when these player meet again in the virtual world, and in the same manner, occurrences and achievements in the virtual world may have an external expression when these players meet in the reality.

Thus, communicating connected toys can enrich the playing experience, and create a new form of playing, both online while connected to a smart device and also while disconnected from a smart device.

Connected toys communication may also improve social experience, for example, when two or more toys meet and transfer information to each other, such as ID and game details, a network of known toys may be created in which, data may be obtained from interactions by virtual communication and implemented when the toys “meet” in the real world, and vice versa, data may be gathered from interaction between toys when they meet in the reality, and transmitted later on to a smart device upon connecting to it after the meeting in the reality has ended and the data may then be analyzed and affect the subsequent meeting of the same toys in the virtual world.

The connected toys and/or connected things are configured and operable to connect to smart devices, such as but not limited to, smartphones, tablets, phablets, smart TV, laptops and PC, by a local application on the smart device. The information exchanged between the toys/things may further be transferred to a web server, thus creating additional connection between the toys and their owners, allowing them to play together from different houses, communicate through the web, send each other virtual goods, and the like.

The present invention is further directed to a method and system for creating interaction between connected toys, having ability to connect to smart devices, but from some reason they are not connected at the moment of interaction. This form of creating interaction between toys and merchandise in their unconnected state, may allow a new way of communication in the real world, when a smart device is not available. Users of toys/connected things may meet other users in offline state conditions, such as, but not limited to, work, public transportation, college, schoolyard, playgrounds, outdoor activities, and the like.

In all the unconnected state conditions mentioned above, toys of different users may meet and would like to remember the meeting, share certain content with each other and perform special activities together. This invention provides a method and a system that allows these actual meetings to influence the game, functions, abilities and state of the toy, identify the meeting and perform special activities, either instantly at the time of the meeting or after connecting to the smart device via a dedicated application, or on both.

### BRIEF DESCRIPTION OF THE DRAWINGS

Examples illustrative of embodiments of the disclosure are described below with reference to figures attached hereto. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings.

The figures (Figs.) are listed below.

FIG. 1A is a schematic illustration of two connected toys interacting with each other when they during a game in the reality while they are unconnected to smart devices;

FIG. 1B is a schematic illustration of either one of the connected toys illustrated in FIG. 1B communicating with a smart device that is further connected to a server, demonstrating the major components required in the connected toys in order to record the data in an unconnected state and further to transmit the data recorded upon connection of the toy to a smart device.

FIGS. 2A-C are state diagrams illustrating in State 1: a connected toy registered with a cloud (FIG. 2A); State 2: an example of interaction between two connected toys in an actual meeting, while both toys are not connected to smart devices; and State 3:

transmission of the data obtained in the actual meeting between the toys to a smart device and a cloud.

FIG. 3 is a schematic illustration of a connected toys system according to examples of the invention.

FIG. 4 is an example of connected scooters “meeting” in the playground away from the smart device that is positioned at home.

### DETAILED DESCRIPTION OF EMBODIMENTS

In the following description, various aspects of an interactive playing system with connected toys having ability to communicate with each other while they are offline and to input and output reactions according to data obtained in the virtual world and in the reality will be described. For the purpose of explanation, specific configurations and details are set forth in order to provide a thorough understanding of the invention.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

Reference is now made to the figures.

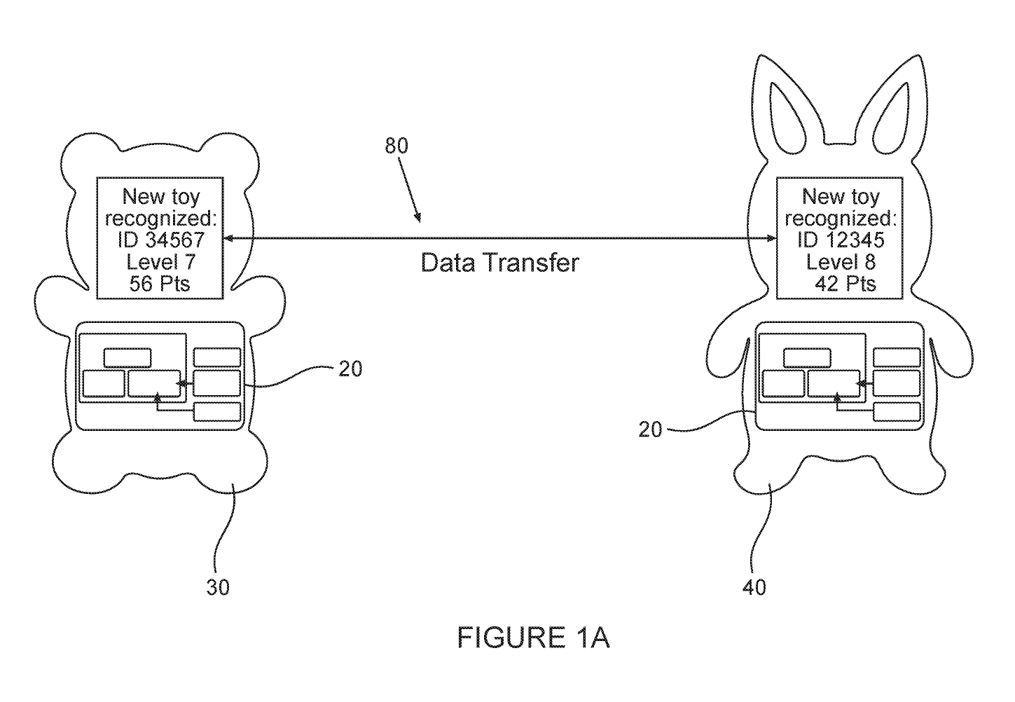

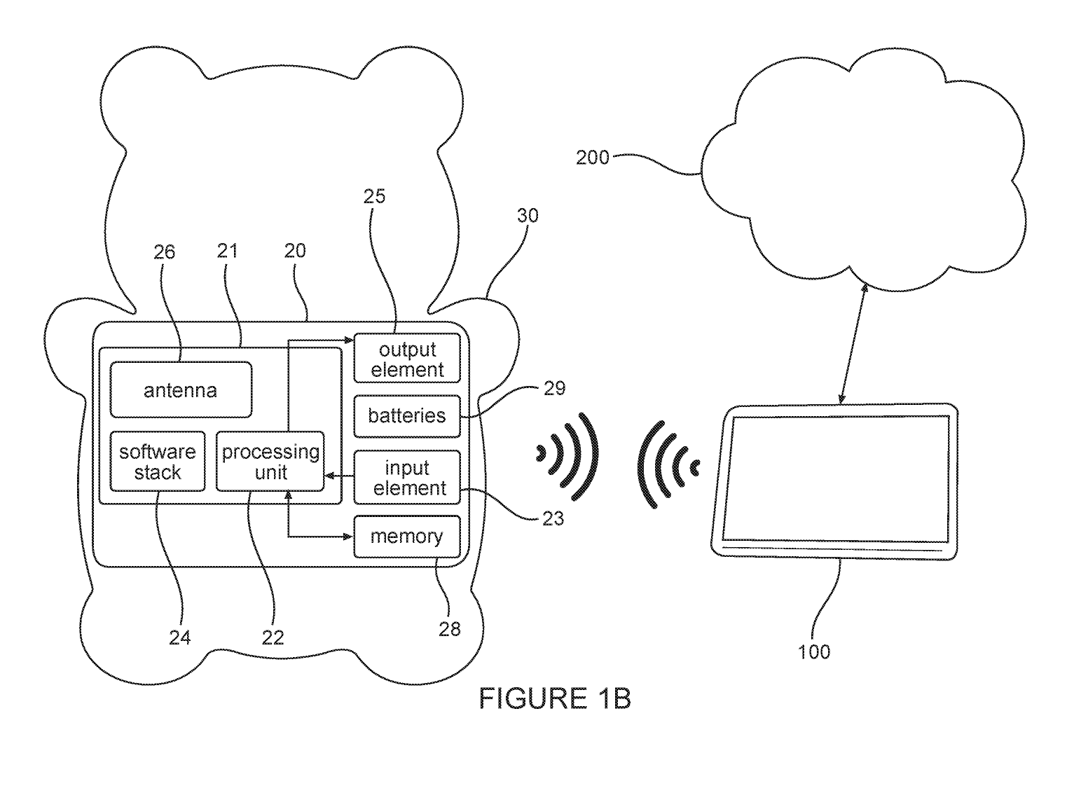

FIG. 1A schematically illustrate two connected toys 30 and 40 interacting with each other during an actual meeting at a specific time and location in the reality, while none of the connected toys is connected to a smart device during this actual meeting. The interaction between the connected toys in the specific example illustrated in this figure is recognition of each other and transfer of data 80 between them, such as but not limited to the toy Identification Number (ID), the level in the virtual game that each toy has reached, and the number of points the toy gained in the virtual game. For this communication to happen, each toy should contain the components illustrated in block 20 that further allows each toy to connect with a smart device as illustrated in FIG. 1B.

FIG. 1B is a schematic illustration of connected toy 30 of FIG. 1A communicating with a smart device 100 that is further connected to a server 200, demonstrating the main components required in order to transmit the data 80 recorded in the actual meeting of the connected toy to smart device 100 and further to server 200. Although FIG. 1B refers to toy 30 the same applies to toy 40. In addition, although the invention is demonstrated on connected toys the same applies to other connected objects and also to a combination of toys and other objects as will be described below.

Connected toys 30 and 40 comprise hardware and firmware, while the software application is installed on the smart device. More specifically, block 20 comprises a communication module 21 composed in the specific example illustrated in this figure from a processing unit 22, a firmware (software stack) 24, and a communication antenna 26 allowing it to connect to another connected toy (or another connected object) and further to connect to a smart device. The software stack 24 runs the communication protocol on the processing unit 22. The communication may be established by various communication technologies, such as but not limited to, Bluetooth, BLE, NFC, and RF; a memory 28 to allow for example recordation of data, and a power source 29 such as batteries. The toy further comprises at least one input elements 23 for example sensors, such as touch sensors, motion sensors, light sensors, movement sensors, Hall Effect sensors, and the like, that will allow the user to manually activate the communication module. The input element may be, for example, a button that once pressed for more than two seconds, wakes the device up. It may also be an accelerometer that, for example, will allow the user to wake the device by shaking the toy five times.

The toy may also include output elements 25 such as speakers, buzzer, LEDs, screen and the like. The input element 23 may also be an operating component such as a button that changes the mode of toy 30 from a power save non used mode to an operating in-use mode. The processing unit 22 reads from the one or more input elements, and uses the memory 28 to save the data received from the smart device and/or other connected toys. The processing unit 22 may also read from the memory 28, for example to read its own unique ID and transmit it to the smart device and/or other connected toys in their non-connected state.

A dedicated software application, installed on the connected smart device 100, may activate these components remotely (from far), according to specific characteristics, and may further respond to the received information coming from additional input elements 23. The connection to the smart device allows the toy an interaction with the app, and this in turn allows social interaction with other users through the internet via server 200.

The output element such as, but not limited to: a speaker, a buzzer, LED, LCD, motor and/or moving parts, may be operated by the processing device in some embodiments, as a reaction to a data received from another toy and/or smart device. For example, if the toy meets a second toy with a known unique ID (a number that already appears in its memory), it flashes an LED or plays a certain melody via a speaker.

In accordance with specific embodiments of the invention provided herein, when a toy disconnect from the virtual world, certain information is still saved on the connected toy. This information may be static or dynamic, thus the software app may have an access to change it dynamically following specific activities made by a player. For example, the toy may include static information about its identity such as ID number, production number and the like, but also dynamic information such as date of last session, number of points earned in the game, achievements, number of virtual friends, and the like. This information may be saved to the toy's memory, thus when the connected toy is not connected to a smart device, the information remains available. Once encountering a second toy in a non-connected state, this information may be transferred to the second toy, and may thus enrich their actual meeting play. For example, each toy may save information about its current level of the game. In this example, once an actual meeting occurs between two or more toys in an unconnected state, the toys may exchange data about their levels, and the toy with the highest level may blink or show other visual or audio response to indicate that it has the highest achievements. Other toys that connect to this specific toy may gain some points for having connection with “a high level toy”, and thus, when returning to the virtual world, they may achieve more points for the fact that they encountered this toy. These types of interactions between the physical and virtual worlds may enrich the play in these two worlds and create a new experience of play.

In some embodiments of the invention, the communication module 21 is configured to allow connection of the toy to the smart device and also to allow connection of the toy to other connected toys upon actual meeting with such other toys at a specific time point and location, while the toys are not being connected to smart devices as long as the other toy/s contain a similar communication module. For example, usage of a BLE component allows an easy and low energy connection between the toys.

The actual meeting at a specific time point and location between two connected objects while they are not connected to smart devices may occur in various combinations and options some of them are listed below:

Actual meeting may occur between at least two connected toys owned by different players, each player has at least one smart device configured to be connected to its toy, for example two friends that are meeting with their toys at school, and each is connected to a smart device when reaching home.

Actual meeting may occur between two or more toys of the same player, each toy as its own characteristics and all are configured to be connected to the same smart device or to a bundle of smart devices of the same user, for example a child that own some connected toys configured to be connected to the smart TV at home and/or to a tablet of the family that is also used by other family members and their connected things.

Actual meeting may also occur between a connected toy and a connected thing of the same user, for example, a connected scooter and a connected bottle that may exchange data while they are used in a similar location during a specific time period and further teach for example, about the drinking habits of the user during exercising extreme stunts on the scooter, and the like.

Actual meeting may also occur between two connected things of different users for example, actual meeting between connected running shoes may allow both users at a later time upon connected of each of them to a smart device, to identify the user in the virtual world and to follow the other user the performances and achievements.

In addition to the above, a second actual meeting as well as any further subsequent actual meetings between the connected objects may had additional expression according to the nature of the connected thing and the type of interaction both in the virtual world and in the reality. Detailed examples of various optional interactions are described with reference to the figures below.

Data may be gathered in two main states: broadcasting and direct connection. In the state of broadcast, toys around the user's toy may transfer specific and well-defined information, such as, but not limited to, toy ID, toy state and signal strength (to infer the toy's distance). In order to make a connection to a certain toy, the software application may connect automatically to a certain toy according to specific features, such as signal strength threshold, or may request an action from the user in order to connect to another connected toy. Such action may be, for example, pressing a button, moving the toy in a certain direction, or physically touching the other toy. The action may be determined according to the specific connected object and according to the specific sensors it contains. For example, two children that gather together and want to connect their toys may use sensor to choose each other, by moving the toys in the same manner, pressing a button on the same time, shaking the toys at the same time, and the like. The toys may identify the action in their environment, and allow further connection to additional toys in their vicinity, when the same action is detected.

Requirement of an active connection may be used in accordance with some embodiments of the invention, for the selection of a friend's toy in the actual meeting and in the virtual environment, especially when it comes to small children and to children safety in virtual environment. For example, it may protect children from undesired connections with strangers. The toy may require identification of another toy and an active choice to connect to it, which will block strangers from gathering information about the player without his permission. The virtual app may further include limitations on connecting with virtual users, i.e. some interactions or permissions may be given only to users which met each other in an actual meeting in the reality and approved each other with the toys in person, thus including only friends which are well known to the child, and preventing unidentified virtual players to get certain information and access to the child. It may further require few actual meetings to occur before allowing certain information to be exposed between them.

Additionally, the broadcast may include some security limitations on the transferred information data size, or may use encrypted communication to transfer information, to ensure privacy. In these cases, only a connection that all participating players approve will open certain functions and allow information exchange.

Other protocols except BLE may be used in order to provide a connection between two or more connected thing, such as but not limited to, Bluetooth, NFC, RF, sound transmission, and light transmission.

In some embodiments of the invention, the information gathered during actual meeting between toys may include, but not limited to: toy ID details, date and time of meeting, and other identifying information about the toy; a list of the toy's achievements, scoring, social networks and any other information about the application and/or game; and personal information about the toy's owner. The information can be kept in the toy's memory 28, and may be kept to a longer term, thus creating a list of all the toys met in a certain period, for example until the player connects to the smart device. In addition, the information itself can change during the actual meeting, thus changing the information sent to other toys. For example, a toy may “meet” with ten friends, thus having ten points. When meeting five more friends, he may get a new achievement of reaching fifteen points. This information changes during the actual meetings with other toys, thus changing the information exchanged with the other toys during the interaction between them in one actual meeting.

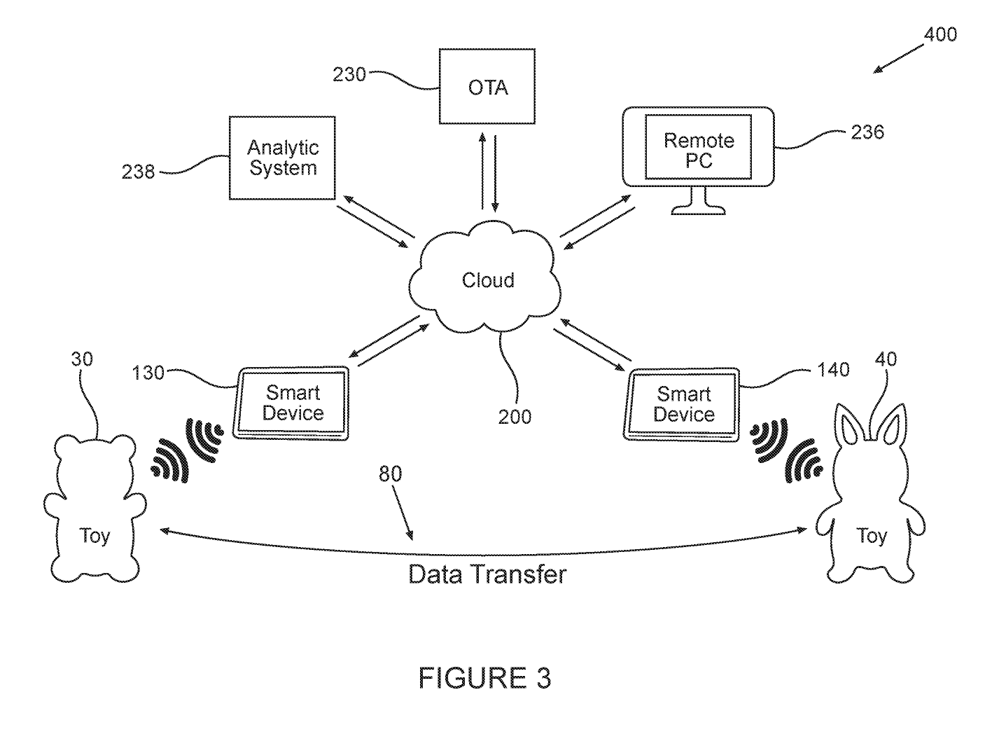

The connected toy/thing may further contain output elements 25 that may further indicate that a connection was made between the objects by a special sound, light and the like. These output elements may further be used to indicate whether the toys encountered are known or unknown to the toy, for example, LED blinking twice for known toys and blinking once for unknown toys. The output sensors may further be customized by the user in the connected state (settings via the smart device), to operate in a certain way in the non-connected state. For example, he may set a certain user as his best friend, and may request the toy to sing a certain song whenever encountering his best friend toy in reality. Following the new settings, when the two toys will meet in the non-connected state, they both will play the song requested. This embodiment will of course require a speaker and a song to be saved on the toy's memory, and/or a possibility to download a song to the toy via the smart device (a detailed explanation is provided with reference to FIG. 3).

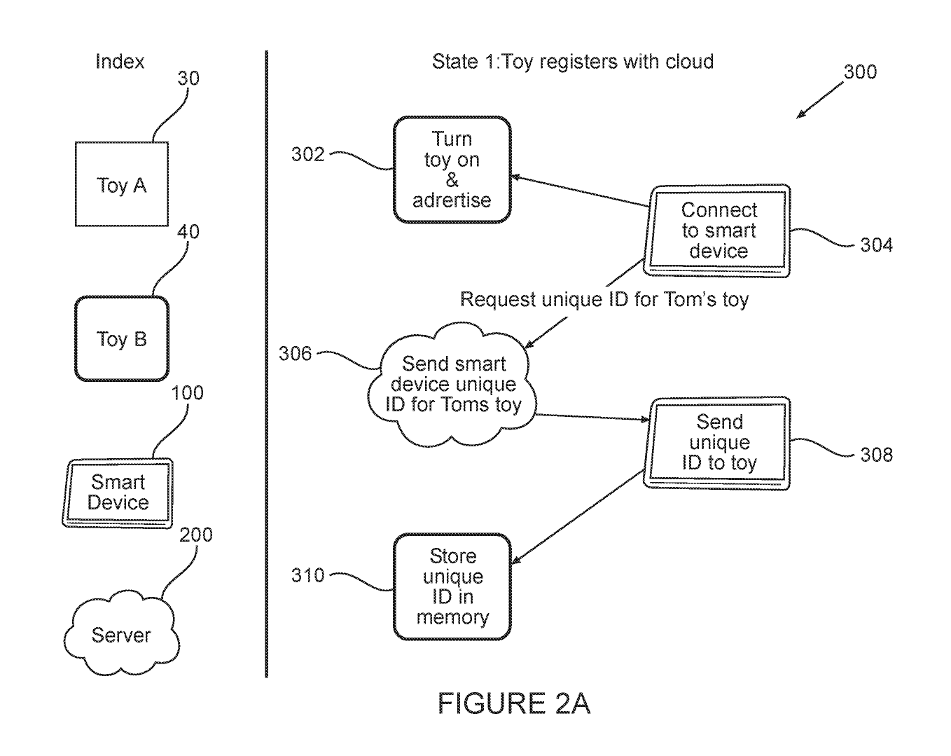

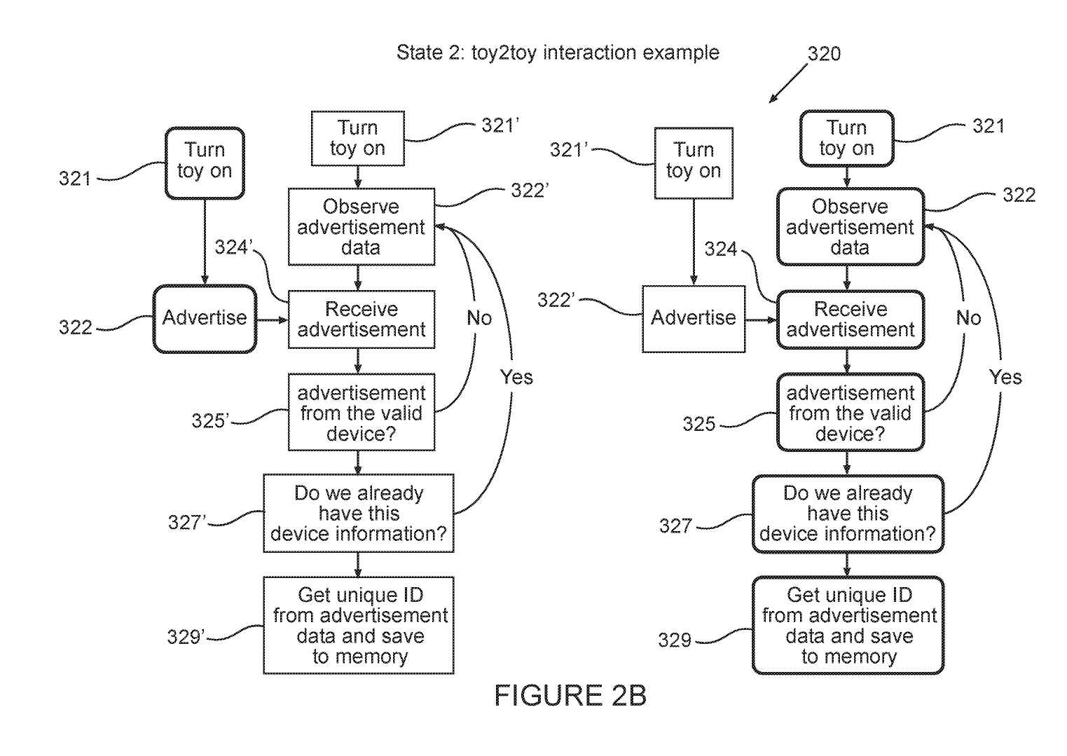

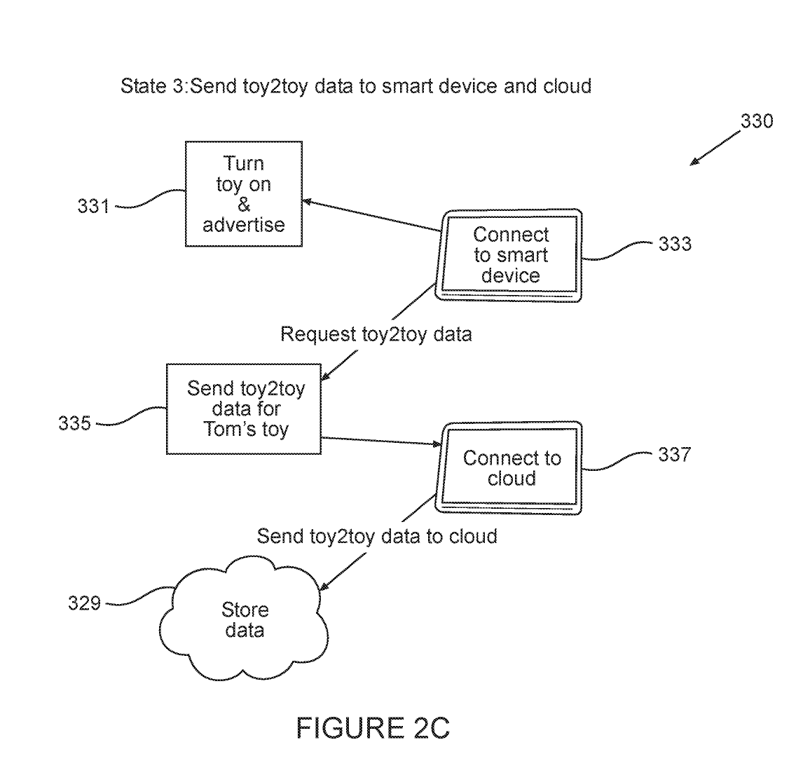

FIGS. 2A-C are state diagrams demonstrating a generic example of toy to toy connection scenarios, wherein State 1 illustrates a connected toy registered with a cloud (FIG. 2A); State 2 illustrates an example of interaction between two connected toys in an actual meeting while they are not connected to smart devices (FIG. 2B); and State 3 illustrate transmission of the data obtained in the actual meeting between the toys to the smart device and a cloud in a later stage upon connection of the toy to the smart device.

In some examples of the invention the basic communication between two toys in an actual meeting may involve two toys advertising to each other without connecting. Advertisement, in the case of Bluetooth Low Energy for example, involves sending out a packet of data by each of the toys. This data can contain custom information such as a unique ID. Each toy will advertise and at the same time observe any other devices that may be advertising at the same time. The toys will not know which devices read its advertisement data and any toy in the vicinity can read the advertisement data. Toy advertisement data also contains space to add custom data that can hold information such as points for a game, how many times a toy has won a game, and the state of input sensors.

In some other examples of the invention the communication of the toys in the actual meeting may include additional functionality of not only advertising each other, but also connecting to each other. For example, assuming that both toys have a communication module 22, once a toy has seen another toy in its vicinity it can then make a connection to it. A connection enables the ability to exchange more complex data. As both toys see each other a rule is needed to decide which toy initiates the connection. This could be done, for example, by using the MAC address (unique address used in communication such as Bluetooth Low Energy and TCP/IP). The toy with the lowest MAC address can initiate the connection. Once a connection is made, the toys can then pass data between them. Thus, in this option the toys may interact with each other in various options. For example, toys may fight each other through movements and sensors, and the winning toy may get bonus points to be saved on his memory. Once connected to the smart device again, the game may be updated with the new points that he earned in the non-connected state. Thus, the un-connected state may influence the connected state and vice versa.

FIG. 2A demonstrates a generic example of a toy registering with cloud (300). This diagram shows the first step of the scenario, a toy 30 registers with cloud 200. In this example, the data of all the unique IDs and their aliases are saved in a database on the cloud 200. Once the toy 30 first connects to the dedicated app on the smart device 100, it starts a registration process to the database on the cloud. This can be done in two manners: in one embodiment, the toy 30 may be manufactured with a unique ID, thus, the unique ID will be assigned in the factory and saved on the toy Firmware. In a second embodiment, the toy may arrive without an ID, and the cloud will assign it to the toy upon the first connection.

At step one (302) toy 30 is being turned on by the user and it starts to advertise. The advertisement process in this example is for Bluetooth Low Energy, thus it involves the toy sending a packet of data that a listening device can intercept. The communication solution is just an example and not limited to Bluetooth low energy. The advertisement data will contain the unique ID for the advertising toy;

At step two (304), once a dedicated software app running on the smart device 100 sees the advertisement data from toy 30 it will connect to it. The smart device will act as a ‘Master’ and connect to any toys it sees advertising. The smart device will recognize that this is the first connection of the toy, and request the user to name the toy. For further explanation of this example toy 30 will be called Tom, and the cloud will store the name along with a unique ID. The app may request the user to add more data when registering, like age, gender, email and the like. All this information may be saved in the cloud 200 and/or in the smart device 100;

At step three (306) (optional), if the toy does not have a unique ID the server will send a new ID to the smart device;

At step four (308) (optional), if step three occurred, the smart device will then inform the toy of its new unique ID; and

At the next step (310) (optional), if steps three and four were needed the toy will store its unique ID in the memory for later use.

FIG. 2B is an example of toy to toy interaction when the two toys are within a close proximity to each other i.e. located at the same room when neither of them are connected to smart device (320). This chart demonstrates two simultaneous processes that will happen when the two toys meet in the non-connected (to the smart devices) state: each one of them will turn on and advertise to the other, and the other will connect to it, and then exchange unique ID's.

At step one (321, 321′) the toys are turned on by the users. At the next step (322, 322′) after being turned on, the toys 30 and 40 will now observe any advertisement packets from other toys in their close environment. In a preferred embodiment, in order to save energy the toys will only search for advertisement data a few times a second. The toys may receive advertisement data from multiple toys at the same time.

At the next step (324, 324′) the toys that are searching for advertisement data receive data from another toy. In this example, Toy 30 has received advertisement data from toy 40, and toy 40 simultaneously received data from toy 30 (assuming that they were already turned on and started to advertise.

If it didn't receive data, the toy (30 and/or 40) will return to step 322, 322′ and will search for toys for a while and if it doesn't find, it will enter a sleep mode (not shown).

If the toys are operating in a passive operation route, in which toy 30 does not know that toy 40 has received its advertisement data and vice versa, the flow ends at this step.

In an advanced route of toy to toy communication, the toys may decide to connect to each other and exchange more data. This data can then be relayed to the smart device later. In such advanced route, at the next step (325, 325′), toy 30 will check that the advertisement data is valid in case that it was from a device that the user is not interested in. In the case of Bluetooth low energy, this may be done using service UUID's and device names. In the case that the device is not valid, toy 30 will continue observing for advertisement data. The same happens with toy 40. At the next step (327,327′) each toy will check if it already has the information, to avoid storing the same unique ID twice. If it finds it already has the device in its memory, it will continue to observe for advertisement data (back to step 322, 322′).

If the toy recognizes that it does not have the new device information it forward to the next step (327, 327′) and get the unique ID of the newly recognized device. The unique ID will now be saved to toy 30 non-volatile memory (i.e. memory whose data persists after losing power, such as FLASH memory, so it can relay the unique ID to a smart device later on.

FIG. 2C shows transmission of the data gathered by the toy while it was not connected to a smart device to the cloud (330). More particularly, this diagram shows toy 30 (or 40) connecting to smart device 100 and sending unique ID's that it found earlier to cloud 200.

At the first step (331) the toy is being turned on by the user and advertisement will start; the next step (333) is similar to step 304 in FIG. 2A, in which the smart device will observe the toys advertisement data and connect to it;

At the next step (335) the smart device will request its unique ID data from the toy. The toy will now send all the unique ID's that it had stored earlier in its memory. If the toys were using advanced toy to toy (designated also as: toy2toy) communication route there may be extra data to transfer to the smart device at this step;

At the next step (337) the smart device 100 will now connect to the cloud 200 (using a technology such as Wi-Fi) and will send the unique ID's that it received from the toy to the cloud;

At the final step (329), the cloud will now store the data it received from the smart device. It may also store other information such as the time and date that the transfer took place. The cloud can now relate any toys that toy 30 has been around with and display this information using the toy's name instead of a unique ID (a same name that was chosen for the toy in the registration process in FIG. 2A).

An example of such session as illustrated in FIGS. 2A to 2C may be, that Tom and Andy were playing together with their toys. Tom's toy stored Andy's unique ID and Andy's toy stored Tom's unique ID. Now after Tom and Andy connect their toy with a smart device and the smart device updates the cloud, the cloud will show that Tom met Andy and Andy met tom.

FIG. 3 is a schematic illustration a connected toy system 400 according to embodiments of the invention demonstrating communication between two connected toys 30 and 40.

The connected toys 30 and 40 are having ability and may connect to smart devices 130 and 140 respectively that in turn may be connected to a server 200. The server may update the local application on the smart devices, and thus to update the virtual game that can be played with the connected toy. Toy 30 and toy 40 may meet at a specific time and location and connect one with the other while they are not connected to a smart device (this state is denoted hereinafter as: “not-connected state”). Toy 40 will send toy 30 its unique ID during the meeting, and vice versa. Later on, connected toy 30 may connect to its smart device 130 and transmit data to it that the toy has met a specific unique ID earlier that day. The smart device 130 transmits this information to the cloud 200, and the cloud searches for the toy with that unique ID. Once it finds toy 40, it transmits the identification to smart Device 130, and/or to smart device 140, or to both, to allow a virtual connection between the two toys.

This novel system allows toy 30 and toy 40 that met each other in their non-connected state, to find each other online and connect their smart devices via the cloud to play together.

Cloud 200 may also send updates to toys 30 and 40 via the smart devices 130 and 140, for example, to save toy 30 unique ID into the memory of toy 40, so that the next time that they meet, the toys will recognize each other automatically. The toys may be further configured to allow an automatic connection to toys that they know, as opposed to unique ID's that are unknown and require a manual connection upon first actual meeting.

The toys may further be configured to change their behavior in the non-connected state when they meet a known toy, for example, to blink simultaneously ten times via three RGD LEDs (that may be present in some toys configurations).

In a further embodiment, the toys may be configured to allow an OTA (over the air) system 230 update of the software stack 24 that runs on the processing unit 22. In this configuration, a remote PC 236 that is preferably run by a service provider such as a game developer, may set a set of criterions to determine which toys should be updated (for example, toys with older software version, toys that arrived to a pre-defined level in the game). The OTA system 230 that sits on the server is configured to send the updates to the relevant toys according to the criteria received from the remote PC, and according to the data coming from the toys themselves via the smart devices. This feature will allow a further flexibility of the toys behavior in the non-connected state, and their responses and actions may vary according to the toys that they meet, the version that is installed and optionally other game criterions. The cloud may further be connected with analytical sub-system 238 that is configured to analyze the meetings history of the toys, best scores, points gathered and ranking compared to other players registered in the system. The analytic sub-system is configured to send back analysis results to the virtual game on said smart devices, so as to allow players to track their achievements and ranking compared to other players in their actual meetings in the unconnected state.

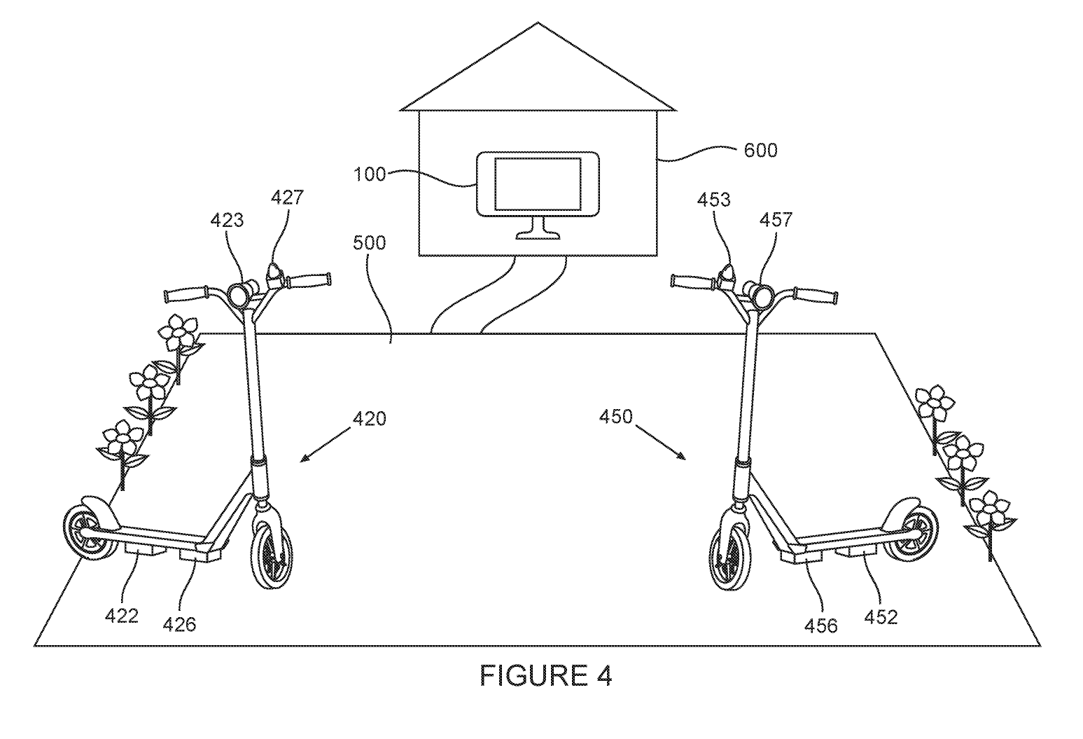

FIG. 4 is an example of two connected scooters 420 and 450 “meeting” at a playground 500 away from the smart devices 100 that are left at home 600.

Each scooter contains a communication module and additional component as illustrated in block 20 of FIG. 1B having a processing unit configured to allow the scooter to calculate a response in accordance to certain data, a memory and a communication module.

Each scooter may include sensors 422 and 452 respectively, such as but not limited to touch sensors, motion sensors, light sensors, movement sensors, and may further include output components such as visual output components 423 and 453 including without limitation LEDs and/or screen, and/or audio output components 427 and 457 such as speakers, buzzers.

The communication channel between the two scooters can be obtain by various communication methods, such as Bluetooth, BLE, NFC, RF, WIFI, and other communication techniques known in the art.

In one specific example, sensors 422 and 452 are accelerometer that allows the scooters to track the moments and record behaviors of the scooters. In this example, the two scooters may conduct a contest at the outdoor of bar twists, speed and stability on the scooter. In this scenario, both scooters may actively record the data coming from all of their own input sensors 422 and 452 respectively, each by its memory unit, they may record any movement registered in the accelerometer, count number of wheel turns and number of bars spins. Each scooter may further transfer the data to the other scooter that may save it on his memory.

Once connected to the smart device, the data is transferred to the dedicated application on the smart device 100 at home 600, that analyzes the data received from the toy and show its achievements history, its progress and further to show the current state of the player relative to his friend and set the winner of this playing session.

The smart device may further send the results to a remote analytic system on the server (not shown), and receive data from the analytic system about the average results in a certain country or the average results for a certain age with the same toy. Thus, the players will be able to measure their achievement in compared to other users. The uniqueness of this invention is that it allows two players to play with two or more toys in a non-connected state, against each other or together, and then to further track their play history and progress via the smart device and server.

In some embodiments, the data that is transmitted from one connected scooter to the other in the non-connected state (i.e. not connected to the smart devices), will be followed by an output, indicating the user who won the contest. For example, if the two players are competing on the number of bar spins, the scooters will record their own number of spins via the input sensor (for example, motion sensor), and transmit this number to the second scooter. Each one of the scooters will compare their own number with the number received from the second scooter, and decide how to operate the output sensors to express the results. For example, for the loosing scooter, it may activate a red LED or a negative feedback melody via its speaker or both, while to the winning scooter, it may activate a greed LED and a winning melody. Thus, the scooters may give an immediate feedback to the users during the competition, while more complex feedback may be received only when the user gets home and connected to the smart device.

The use of scooters is only an example, and the connected objects in use for the game may be for example, playing balls, bicycles, rackets, and the like.

In further embodiments and implementations of the invention, the connected object hardware may further include, but not limited to, an internal timer which enables it to wake itself in a specific date and/or time. This timer may also allow the object to enter into a sleep mode, thus save battery between sessions. The timer may be further programed with an event to alert the user every predefined period of time, to connect the object to the smart device in order to update the latest information to the object.

The output events of the physical product may include, but not limited to, making a sound, lighting lights of different colors, vibration, movements and so on. The operation may general, such as a general alert to all kind of events, or may further be event specific. For example, a meeting with player A may operate the sound: “Player A is waiting for you”, and a number of LEDs will blink in a unique way.

This description is only one specific example of use of our invention. The product may include versatile output components, such as, but not limited to: LEDs, Buzzers, speakers, vibrator, and mechanical parts (in the example of the toy, eyes blinking or tale movement).

The Consumer product may be a toy, such as a doll, plush toy, car, dollhouse, game board and the like. It may also be accessories and other connected consumer electronics products which may benefit from data transfer to/from other similar products.

The connection with other toys may be personally updated, according to specific requested definitions of the user, or spontaneous decision made by the providing company, such as special powers or features that can be used in the offline state. For example, a user getting to level 10 in a certain game app, may get different score then a user an level 5, and thus win an offline battle.

Users may also turn off the toy, thus disabling communication with other toys in the vicinity.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A connected toy comprising a toy configured to interact with at least one other connected toy upon actual meeting of the toys in a state that the toys are not connected to a smart device, wherein said interaction allows the toy to recognize the at least one other toy and/or to exchange data with said at least one other toy, said recognition data and/or data exchanged between them is being saved on the toy and uploaded to a smart device upon reconnection of the toy to said smart device for reporting the smart device that an interaction between the toys has occurred, and to allow the smart device to make use of the data exchanged.

2. A connected toy according to claim 1, wherein said data being exchanged with the at least one other connected toy in an unconnected state and uploaded to a smart device is selected from the group consisting of: the unique ID of the other toy, the time of the encounter with the other toy, virtual game achievements of the other toy, offline game achievements of the other toy, data received from input and/or output elements of the other toy, and historic data on past encounters with the other toy.

3. A connected toy according to claim 1, wherein said toy comprises a memory which allows it to save data received from the at least one other toy to its memory, said data saved is selected from the group consisting of: the unique ID of toys, the time of encounter with the other toy/s, the virtual game achievements, the offline game achievements, the data coming from input and/or output elements of a toy, and the historic data on past encounters.

4. A connected toy according to claim 3, wherein said ability to interact with at least one other connected toy is obtained by a communication module integrated within said connected toys, said memory, and at least one input element, wherein said communication module comprises at least a processing unit, a software stack and antenna and configured to allow said connected toy to communicate with other connected toy and with a smart device.

5. A connected toy according to claim 4, wherein said input element is configured to allow said connected toy to change mode from a power saved unused mode to an operating in-use mode.

6. A connected toy according to claim 4, wherein said input element is a sensor configured to provide inputs from the surroundings to said communication module.

7. A connected toy according to claim 1, wherein said interaction with said connected toy upon actual meeting while the toys are not connected to a smart device is enabled after each toy performs a specific movement or a sequence of movements.

8. A connected toy according to claim 1, further comprising at least one output element, wherein upon connecting to and/or receiving data from said at least one other toy in the unconnected state said toy responds by operating at least one output element, to produce an audio and/or a visual signal that is related to the interaction between said toys.

9. A connected toy according to claim 1, further configured to do at least one of the following actions: (a) to process data received from said at least one other toy and to send data back to the at least one other toy in response to the data received, (b) to process data received and save it on its memory, (c) to process data received and operate an output element on the toy as a response.

10. A connected toy according to claim 1, wherein upon connection to the smart device, said smart device uses the exchanged data in at least one of the following manners: sends the data to a remote server and identify the at least one other toy, receives data from said remote server about the at least one other toy, connects and/or plays with the at least one other toy in an online game via the server, presents a virtual character of the toy and/or with a virtual character of said at least one other toy, sends data to the at least one other toy, presents data coming from additional toys previously identified by said smart device, sends the data to an analytic system, receives data from an analytic system about said toy and/or about said at least one other toy, updates the toy to recognize the at least one other toy in their next meeting, sends new configuration package to the toy to respond in a specific way each time the toy will meet the at least one other toy.

11. A connected toy according to claim 1, wherein following a virtual meeting of pre-identified connected toys, data created in said virtual interaction is being downloaded from the smart device to said connect toy and expressed in a subsequent meeting/s in an unconnected state with said pre-identified toy by at least one output element comprised in the connected toy.

12. A connected toy according to claim 1, configured to receive software updates from time to time from said smart device upon connection to it, and respond in different manners while being in an unconnected state according to the software updates received from said smart device.

13. A connected toys system configured to allow data transmission from a game occurring in the reality to a virtual game of the same connected toys, said system comprising:
a. at least two connected toys configured to interact with each other upon actual meeting of said toys in a state that they are not connected to a smart device;
b. at least two smart devices each is configured to be connected to one of said connected toys; and
c. a server configured to connect with said at least two smart devices;
wherein data obtained in said actual meeting is configured to be transferred to the smart devices in a state where each of said connected toys is connected to its smart device, and said smart devices are configured to send said data to a server and receive information and/or other data about the connected toy that it is not connected to.

14. A connected toys system according to claim 13, wherein said server contains a database of all connected toys registered into the system, and their unique IDs, usernames and/or personal details, allowing said connected toys to further recognize each other in the virtual world after an actual meeting in an unconnected to a smart device state has occurred.

15. A connected toys system according to claim 13, wherein data exchanged via the server allows each of the toys to connect to each other in a virtual game, and play together on the said smart devices, and wherein data obtained in said virtual game, whether if the toys play together or if each toy plays alone, is configured to be sent to the connected toys and to be saved on the connected toys memory, to influence actual meetings between said connected toys in subsequent games in the reality in a state where each of the toys is unconnected to its smart device.

16. (canceled)

17. A connected toys system according to claim 13, wherein said connection to the server allows performance of analytics by an analytic sub-system on the data gathered from said connected toys games in said actual meetings, and to analyze their meetings history, best scores, points gathered and ranking compared to other players registered in the system.

18. A connected toys system according to claim 17, wherein said analytic sub-system is configured to send back analysis results to the virtual game on said smart devices, so as to allow players to track their achievements and ranking compared to other players in their actual meetings in the unconnected state.

19. A connected toys system according to claim 13, further comprising a remote PC allowing the virtual game between said connected toys to be updated from time to time via said server.

20. A connected toys system according to claim 13, further comprising an Over The Air update system, allowing said server to send update packages to the said smart devices upon pre-defined criterions set by a remote PC, to allow said smart devices to send the over the air update to the connected toys and change their software stack to so as to allow a new interaction between the connected toys in their actual meeting in the unconnected state.

21. A connected toys system according claim 13, wherein at least two connected toys are connected to one smart device.

22. A connected toys system according to claim 13, wherein said connected toy is configured to interact with least one other connected toy upon actual meeting of the toys in a state that the toys are not connected to a smart device, wherein said interaction allows the toy to recognize the at least one other toy and/or to exchange data with said at least one other toy, said recognition data and/or data exchanged between them is being saved on the toy and uploaded to a smart device upon reconnection of the toy to said smart device for reporting the smart device that an interaction between the toys has occurred, and to allow the smart device to make use of the data exchanged.
